(19) United States
(12) Patent Application Publication
(10) Pub. No.: US 2024/0122784 A1
(43) Pub. Date: Apr. 18, 2024

(54) FASHIONABLE AND DISCREET DEEP PRESSURE THERAPY GARMENTS

(71) Applicant: Sarah Catherine Roberts, Roswell, GA (US)

(72) Inventor: Sarah Catherine Roberts, Roswell, GA (US)

(21) Appl. No.: 17/964,102

(22) Filed: Oct. 12, 2022

(51) Int. Cl. A61H 9/00; A41D 1/04

(52) U.S. Cl. CPC A61H 9/005; A41D 1/04

(57) ABSTRACT

The present invention provides a fashionable and discrete therapeutic garment for administering deep pressure therapy to the lower torso. The garment comprises a compression layer which is capable of applying uniform pressure to an area of the lower torso. The outer layer is capable of covering the compression layer such that the garment appears as a typical article of fashion.

### TECHNICAL FIELD

The present invention relates to an article of clothing capable of providing a therapeutic effect. More specifically, the invention relates to a fashionable article of clothing capable of discreetly applying deep pressure therapy to the lower torso area.

### BACKGROUND

Sensory Processing Disorder (SPD) is a condition in which the brain has trouble receiving and responding to information that comes via the senses. People with Autism Spectrum Disorder (ASD), Attention deficit hyperactivity disorder (ADHD), or other developmental delays often also experience SPD. The Centers for Disease Control and Prevention estimates that 6 million (9.8%) of children ages 3-17 have been diagnosed with ADHD, (https://www.cdc.gov/ncbddd/adhd/data.html downloaded Oct. 5, 2022) 1 in 44 children have been identified with ASD, and 1 in 6 (17%) children ages 3-17 years were diagnosed with a developmental disability. https://www.cdc.gov/ncbddd/autism/data.html (downloaded Oct. 5, 2022).

A child (or adult) takes information in through her senses. These include auditory (sound/hearing), visual (sight), olfactory (smell), gustatory (taste), tactile (touch), vestibular (movement), proprioceptive (input from muscles and joints) and interoception (internal sensors indicating physiological conditions). Life with SPD makes at least some ordinary sights, textures, and noises unbearable. The body responds to these stimuli in an atypical way which can be observed in motor, language, or social-emotional difficulties. SPD can cause a lot of anxiety.

One of the most successful treatments of SPD is deep pressure therapy. Like how it sounds, DPT works by applying constant pressure around the whole body of the affected, which in turn reduces the stress hormone cortisol and releases dopamine in the body. While compression vests can be effective, they are difficult to get on and off, and typically can only be worn for 20 minutes to 50 minutes at a time. Also, the compression vests are not very fashion forward as they typically are not characterized by the latest trends in fashion.

There is a need for a deep pressure therapy garment that can be easily put on and taken off of a person with SPD. There is also a need for a deep pressure therapy garment that can be worn for an extended period of time. There is a need for a garment that provides a comforting squeeze, similar to a hug, in order to alleviate the stress of different stimuli. And there is a need for a garment with these therapeutic features that is discreet, and even fashionable.

### SUMMARY

In one exemplary embodiment, the present disclosure provides a therapeutic torso garment comprising a compression layer and an outer layer. The compression layer has a compression-layer back, a compression-layer front-right side, and a compression-layer front-left side, wherein the compression-layer front-right side and the compression-layer front-left side are adaptively connectable to form a closed compression-layer front. The outer layer has an outer-layer back, an outer-layer front-right side, and an outer-layer front-left side, wherein the outer-layer front-right side and the outer-layer front-left side are adaptively connectable to form a closed outer-layer front. The compression layer is capable of applying uniform pressure to an area of a lower torso covered by the compression layer when the garment is configured with the closed compression-layer front. The outer layer is capable of covering the compression layer when the garment is configured with the closed compression-layer front and the closed outer-layer front.

In another exemplary embodiment, the present disclosure provides a therapeutic jacket comprising: a compression layer and an outer layer The compression layer has a compression-layer back, a compression-layer front-right side, and a compression-layer front-left side, wherein the compression-layer front-right side and the compression-layer front-left side are adaptively connectable to form a closed compression-layer front. The outer layer has an outer-layer back, an outer-layer front-right side, and an outer-layer front-left side, wherein the outer-layer front-right side and the outer-layer front-left side are adaptively connectable to form a closed outer-layer front. The compression layer is capable of applying uniform pressure to an area of a lower torso covered by the compression layer when the jacket is configured with the closed compression-layer front. The outer layer is capable of covering the compression layer when the jacket is configured with the closed compression-layer front and the closed outer-layer front.

In yet another exemplary embodiment, the present disclosure provides a therapeutic jacket comprising a compression layer and an outer layer. The compression layer has a compression-layer back, a compression-layer front-right side, a compression-layer front-left side, and a compression-layer zipper, wherein the compression-layer zipper is capable of adaptively connecting the compression-layer front-right side and the compression-layer front-left side to form a closed compression-layer front. The outer layer has an outer-layer back, an outer-layer front-right side, an outer-layer front-left side, and an outer-layer zipper, wherein the outer-layer zipper is capable of adaptively connecting the outer-layer front-right side and the outer-layer front-left side to form a closed outer-layer front. The compression layer is capable of applying uniform pressure to an area of a lower torso covered by the compression layer when the jacket is configured with the closed compression-layer front. The outer layer is capable of covering the compression layer when the jacket is configured with the closed compression-layer front and the closed outer-layer front. The compression layer comprises 3 weight percent to 15 weight percent spandex based upon the total weight of the compression layer and further comprises nylon, polyester, and/or cotton. The compression layer is stretchable in a direction parallel to a bottom edge of the compression-layer back. The jacket, when configured with the closed compression-layer front, can be comfortably worn by a person for a time period from 1 to 14 hours.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a front schematic of a non-limiting embodiment of a compression layer;

FIG. 2 is a back schematic of the same non-limiting embodiment of the compression layer as shown FIG. 1;

FIG. 3 is a front schematic of the same non-limiting embodiment of the compression layer as shown in FIG. 1, located inside of a non-limiting embodiment of the jacket; and

FIG. 4 is a front schematic of the same non-limiting embodiment of a compression layer showing the attachment locations where the compression layer is attached to the corresponding location of the outer layer.

### DETAILED DESCRIPTION

In one exemplary embodiment, the present disclosure provides a therapeutic torso garment comprising a compression layer and an outer layer. The compression layer has a compression-layer back, a compression-layer front-right side, and a compression-layer front-left side, wherein the compression-layer front-right side and the compression-layer front-left side are adaptively connectable to form a closed compression-layer front. The outer layer has an outer-layer back, an outer-layer front-right side, and an outer-layer front-left side, wherein the outer-layer front-right side and the outer-layer front-left side are adaptively connectable to form a closed outer-layer front. The compression layer is capable of applying uniform pressure to an area of a lower torso covered by the compression layer when the garment is configured with the closed compression-layer front. The outer layer is capable of covering the compression layer when the garment is configured with the closed compression-layer front and the closed outer-layer front.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

As used herein, the term “and/or”, when used in a list of two or more items, means that any one of the listed items can be employed by itself, or any combination of two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the term “therapeutic torso garment” refers to an article of clothing to be worn on the torso that provides a therapeutic benefit to the person wearing the article of clothing. Non-limiting examples of a “therapeutic torso garment” and a therapeutic jacket and a therapeutic shirt.

As used herein, the term “compression layer” refers to the interior section of the garment that is capable of fitting snugly around at least part of the lower torso of a person wearing the garment.

As used herein, the term “outer layer” refers to the exterior section of the garment. The “outer layer” is readily visible and, among other things, provides the fashion discretion elements of the garment. As used herein, the term “capable of covering” refers to the ability to keep something from being visible.

As used herein, the terms, “back”, “front-left side”, and “front-right side” refer to sections of the “compression layer” and/or the “outer layer”. The “front-left side” and “front-right side” are the sides of the front as experienced by a person wearing the garment. As used herein, the terms “outside” and “inside” of a section of the garment, such as the “outside” of the “outer layer”, refers to the side of the “outer layer” that is visible when the garment is worn normally. The “inside” of the “outer layer” refers to the opposite side of the “outside” of the “outer layer”. The “inside” of the “compression layer”, refers the side of the compression layer closest to the torso, as worn. As used herein, the term “top” refers to the top of the garment, as worn, and the term “bottom” refers to the bottom of the garment, as worn. As used herein, the term “edge” refers to the area near the border of a section of the garment.

As used herein, the term “adaptively connectable” refers to the ability to repeatedly connect and disconnect two sections of the garment. For example, the outer-layer front-left side is “adaptively connectable” to the outer layer front-right side, refers to the fact that the two sides and be connected and separated over and over again. A non-limiting way to adaptively connect the outer-layer front-left side to the outer-layer front-right side is with a zipper. Correspondingly, as used herein, the term “closed outer-layer front”, refers to the outer-layer left-side front and outer-layer right-side front connected together.

As used herein, the term “is configured with” refers to the particular state of the sections of the garment that are adaptively connectable. For example, if the compression layer “is configured with the closed compression-layer front”, then the compression-layer right-front side and left-front side are connected.

As used herein, the term “corresponding parts” refers to the analogous parts in the compression layer and the outer layer. For example, the compression layer front-right side and the outer layer-front-right side are “corresponding parts”.

The compression layer is cable of providing deep pressure therapy to a person while wearing the therapeutic torso garment. In some aspects, when a person wears the garment configured with the closed compression-layer front, the compression layer provides deep pressure therapy to the person. In some aspects, when a person wears the garment configured with the closed compression-layer front, the compression layer provides deep pressure therapy to the person which leads to the person experiencing a reduction in anxiety. In some aspects, when a person wears the garment configured with the closed compression-layer front, the person experiences a reduction in anxiety.

The compression layer is stretchable. In some aspects, the compression layer exhibits 2-way stretch. In some aspects, the compression layer exhibits 4-way stretch. In some aspects, the compression layer is stretchable in a direction parallel to a back-bottom edge of the compression-layer. In other words, the compression layer stretches around the lower torso when worn. In some aspects, the compression layer comprises spandex. In some aspects, the compression layer also comprises nylon, polyester, cotton, and/or wool. In some aspects, the compression layer also comprises nylon, polyester, and/or cotton. In some aspects, the compression layer also comprises nylon and/or polyester. In some aspects, the compression layer comprises 3 weight percent to 15 weight percent spandex based upon the total weight of the compression layer. Other non-limiting examples of the amount of spandex are 3 weight percent to 12 weight percent, or 5 weight percent to 15 weight percent spandex based upon the total weight of the compression layer.

The construction of the compression layer is not particularly limited as long as the compression layer is capable of providing uniform pressure around an area of the lower torso. In some aspects, the compression-layer back, the compression-layer front right-side, and the compression-layer front left-side are three different pieces of material sewn together. In some aspects, the compression-layer back, the compression-layer front right-side, and the compression-layer front left-side are made from a continuous piece of material and there are no compression-layer side seams.

The therapeutic torso garment is constructed to provide a constant pressure by the compression-layer to an area of the lower torso when worn with the compression-layer configured with a closed compression-layer front. In some aspects, the uniform pressure applied by the compression layer is equivalent to a hug being given to a person. Unlike most compression tops, the relatively low level of uniform pressure allows a person to wear the therapeutic torso garment for extended periods of time. In some aspects, the garment, when configured with the closed compression-layer front is capable of being comfortably worn by a person for a period of time from 1 hour to 14 hours. In other non-limiting examples, the garment, when configured with the closed compression-layer front is capable of being comfortably worn by a person for a period of time from 1 hour to 12 hours, or 1 hour to 10 hours, or 1 hour to 8 hours, or 1 hour to 6 hours, or 1 hour to 4 hours, from 1.5 hours to 12 hours, or 1.5 hours to 10 hours, or 1.5 hours to 8 hours, or 1.5 hours to 6 hours, or 1.5 hours to 4 hours, or 2 hours to 12 hours, or 2 hours to 10 hours, or 2 hours to 6 hours, or 2 hours to 4 hours.

The therapeutic torso garment comprises a compression layer and an outer layer. The compression layer and outer layer are attached in a manner that does not disrupt the uniform pressure applied to an area of a lower torso by the compression layer when configured with the closed compression-layer front. How the attachment is done is not particularly limited. In some aspects, the compression layer is adaptively attached to the outer layer. In some aspects, a zipper, hook and loop fasteners, snaps and/or buttons are used to adaptively attach the compression layer to the outer layer. In some aspects, parts of the compression layer are sewn to the corresponding parts of the outer layer.

In some aspects, the compression layer fits within the outer layer. In some aspects, at least some parts of the outside of the compression layer contact corresponding parts of the inside of the outer layer. In some aspects, the top-back edge of the compression layer is attached to the top-back edge of the outer layer. In some aspects, the back-left armhole of the compression layer is attached to the back-left armhole of the outer layer, and the back-right armhole of the compression layer is attached to the back-right armhole of the outer layer. In some aspects, the left front of the compression layer is attached to the left front of the outer layer along a line parallel to a left-front edge of the compression layer and a left-front edge of the outer layer. As described thus far, the compression layer is basically hanging inside the outer layer. In some aspects, the left front of the compression layer is attached to the left front of the outer layer along a line parallel to a left-front edge of the compression layer and a left-front edge of the outer layer. In some aspects, the right front of the compression layer is attached to the right front of the outer layer along a line parallel to a right-front edge of the compression layer and a right-front edge of the outer layer. In some aspects, the attachment is made by sewing. In some aspects, the attachment is made using a zipper. In some aspects, the left armhole of the compression layer is attached to the left armhole of the outer layer, and the right armhole of the compression layer is attached to the right armhole of the outer layer. Attaching the compression layer to the outer layer in this manner allows the majority of the compression layer to freely stretch and provide uniform pressure to an area of a lower torso when the garment is configured with the closed compression-layer front.

The exact location of the attachment line parallel to the left-front edge and the left-front ledge is not particularly limited. Neither is the exact location of the attachment line parallel to the right-front edge and the right-front edge. The distance between these attachment lines and the corresponding edges is based upon the balance between needing room to perform the adaptable connection between the compression-layer front-right side and the compression-layer front-left side, and the desire to have the compression layer to stretch freely around as much of the lower torso as possible.

The compression-layer front-right side and the compression-layer front-left side are adaptively connectable to form a closed compression-layer front. This allows the compression layer to apply a uniform pressure to an area of a lower torso covered by the compression layer when the compression-layer front-right side and compression-layer front-left sides are connected. In some aspects, the compression layer comprises a zipper, hook and loop fasteners, snaps, and/or buttons to adaptively connect the compression-layer front-right side and the compression-layer front-left side. In some aspects, the compression layer comprises a zipper to adaptively connect the compression-layer front-right side and the compression-layer front-left side.

The outer-layer front-right side and the outer-layer front-left side are adaptively connectable to form a closed outer-layer front. The outer layer is capable of covering the compression layer when the garment is configured with the closed compression-layer front and the closed outer-layer front. In other words, the compression layer is not visible when the compression layer is closed (i.e., the compression layer is configured with the closed compression-layer front) and the outer layer is closed (i.e., the outer layer is configured with the closed outer-layer front). In some aspects, the outer layer comprises a zipper, hook and loop fasteners, snaps, and/or buttons to adaptively connect the outer-layer front-right side and the outer-layer front-left side. In some aspects, the outer layer comprises a zipper to adaptively connect the outer-layer front-right side and the outer-layer front-left side.

Many people who would benefit from the present invention and its treatment of sensory perception disorder have one or more other disorders. As such, is some aspects, the compression layer further comprising at least one port access point. In some aspects, the at least one port access point is capable of providing access to a vagus nerve stimulator and/or gastric tube.

In some aspects, the garment is a jacket, a vest, a sweater, or a shirt. In some aspects, the garment is a jacket or a vest. In some aspects, the garment is a jacket. In some aspects, the garment is capable of being the outermost layer of clothing worn by a person, making it convenient to put on and to take off. In some aspects, the garment is machine washable.

In another exemplary embodiment, the present disclosure provides a therapeutic jacket comprising: a compression layer and an outer layer The compression layer has a compression-layer back, a compression-layer front-right side, and a compression-layer front-left side, wherein the compression-layer front-right side and the compression-layer front-left side are adaptively connectable to form a closed compression-layer front. The outer layer has an outer-layer back, an outer-layer front-right side, and an outer-layer front-left side, wherein the outer-layer front-right side and the outer-layer front-left side are adaptively connectable to form a closed outer-layer front. The compression layer is capable of applying uniform pressure to an area of a lower torso covered by the compression layer when the jacket is configured with the closed compression-layer front. The outer layer is capable of covering the compression layer when the jacket is configured with the closed compression-layer front and the closed outer-layer front.

The compression layer is capable of providing deep pressure therapy to a person while wearing the therapeutic jacket. In some aspects, when a person wears the jacket configured with the closed compression-layer front, the compression layer provides deep pressure therapy to the person. In some aspects, when a person wears the jacket configured with the closed compression-layer front, the compression layer provides deep pressure therapy to the person which leads to the person experiencing a reduction in anxiety. In some aspects, when a person wears the jacket configured with the closed compression-layer front, the person experiences a reduction in anxiety.

The compression layer is stretchable. In some aspects, the compression layer exhibits 2-way stretch. In some aspects, the compression layer exhibits 4-way stretch. In some aspects, the compression layer is stretchable in a direction parallel to a back-bottom edge of the compression-layer. In other words, the compression layer stretches around the lower torso when worn. In some aspects, the compression layer comprises spandex. In some aspects, the compression layer also comprises nylon, polyester, cotton, and/or wool. In some aspects, the compression layer comprises nylon, polyester, and/or cotton. In some aspects, the compression layer comprises nylon and/or polyester. In some aspects, the compression layer comprises 3 weight percent to 15 weight percent spandex based upon the total weight of the compression layer. Other non-limiting examples of the amount of spandex are 3 weight percent to 12 weight percent, or 5 weight percent to 15 weight percent spandex based upon the total weight of the compression layer.

The construction of the compression layer is not particularly limited as long as the compression layer is capable of providing uniform pressure around an area of the lower torso. In some aspects, the compression-layer back, the compression-layer front right-side, and the compression-layer front left-side are three different pieces of material sewn together. In some aspects, the compression-layer back, the compression-layer front right-side, and the compression-layer front left-side are made from a continuous piece of material and there are no compression-layer side seams.

The therapeutic jacket is constructed to provide a constant pressure by the compression-layer to an area of the lower torso when worn with the compression-layer configured with a closed compression-layer front. In some aspects, the uniform pressure applied by the compression layer is equivalent to a hug being given to a person. Unlike most compression tops, the relatively low level of uniform pressure allows a person to wear the therapeutic jacket for extended periods of time. In some aspects, the jacket, when configured with the closed compression-layer front is capable of being comfortably worn by a person for a period of time from 1 hour to 14 hours. In other non-limiting examples, the jacket, when configured with the closed compression-layer front is capable of being comfortably worn by a person for a period of time from 1 hour to 12 hours, or 1 hour to 10 hours, or 1 hour to 8 hours, or 1 hour to 6 hours, or 1 hour to 4 hours, or 1.5 hours to 12 hours, or 1.5 hours to 10 hours, or 1.5 hours to 8 hours, or 1.5 hours to 6 hours, or 1.5 hours to 4 hours, or 2 hours to 12 hours, or 2 hours to 10 hours, or 2 hours to 6 hours, or 2 hours to 4 hours.

The therapeutic jacket comprises a compression layer and an outer layer. The compression layer and outer layer are attached in a manner that does not disrupt the uniform pressure applied to an area of a lower torso by the compression layer when configured with the closed compression-layer front. How the attachment is done is not particularly limited. In some aspects, the compression layer is adaptively attached to the outer layer. In some aspects, a zipper, hook and loop fasteners, snaps and/or buttons are used to adaptively attach the compression layer to the outer layer. In some aspects, parts of the compression layer are sewn to the corresponding parts of the outer layer.

In some aspects, the compression layer fits within the outer layer. In some aspects, at least some parts of the outside of the compression layer contact corresponding parts of the inside of the outer layer. In some aspects, the top-back edge of the compression layer is attached to the top-back edge of the outer layer. In some aspects, the back-left armhole of the compression layer is attached to the back-left armhole of the outer layer, and the back-right armhole of the compression layer is attached to the back-right armhole of the outer layer. In some aspects, the left front of the compression layer is attached to the left front of the outer layer along a line parallel to a left-front edge of the compression layer and a left-front edge of the outer layer. As described thus far, the compression layer is basically hanging inside the outer layer. In some aspects, the left front of the compression layer is attached to the left front of the outer layer along a line parallel to a left-front edge of the compression layer and a left-front edge of the outer layer. In some aspects, the right front of the compression layer is attached to the right front of the outer layer along a line parallel to a right-front edge of the compression layer and a right-front edge of the outer layer. In some aspects, the attachment is made by sewing. In some aspects, the attachment is made using a zipper. In some aspects, the left armhole of the compression layer is attached to the left armhole of the outer layer, and the right armhole of the compression layer is attached to the right armhole of the outer layer. Attaching the compression layer to the outer layer in this manner allows the majority of the compression layer to freely stretch and provide uniform pressure to an area of a lower torso when the jacket is configured with the closed compression-layer front.

The exact location of the attachment line parallel to the left-front edge and the left-front ledge is not particularly limited. Neither is the exact location of the attachment line parallel to the right-front edge and the right-front edge. The distance between these attachment lines and the corresponding edges is based upon the balance between needing room to perform the adaptable connection between the compression-layer front-right side and the compression-layer front-left side, and the desire to have the compression layer to stretch freely around as much of the lower torso as possible.

The compression-layer front-right side and the compression-layer front-left side are adaptively connectable to form a closed compression-layer front. This allows the compression layer to apply a uniform pressure to an area of a lower torso covered by the compression layer when the compression-layer front-right side and compression-layer front-left sides are connected. In some aspects, the compression layer comprises a zipper, hook and loop fasteners, snaps, and/or buttons to adaptively connect the compression-layer front-right side and the compression-layer front-left side. In some aspects, the compression layer comprises a zipper to adaptively connect the compression-layer front-right side and the compression-layer front-left side.

The outer-layer front-right side and the outer-layer front-left side are adaptively connectable to form a closed outer-layer front. The outer layer is capable of covering the compression layer when the garment is configured with the closed compression-layer front and the closed outer-layer front. In other words, the compression layer is not visible when the compression layer is closed (i.e., the compression layer is configured with the closed compression-layer front) and the outer layer is closed (i.e., the outer layer is configured with the closed outer-layer front). In some aspects, the outer layer comprises a zipper, hook and loop fasteners, snaps, and/or buttons to adaptively connect the outer-layer front-right side and the outer-layer front-left side. In some aspects, the outer layer comprises a zipper to adaptively connect the outer-layer front-right side and the outer-layer front-left side.

Many people who would benefit from the present invention and its treatment of sensory perception disorder have one or more other disorders. As such, is some aspects, the compression layer further comprising at least one port access point. In some aspects, the at least one port access point is capable of providing access to a vagus nerve stimulator and/or gastric tube.

In some aspects, the jacket is machine washable.

In yet another exemplary embodiment, the present disclosure provides a therapeutic jacket comprising a compression layer and an outer layer. The compression layer has a compression-layer back, a compression-layer front-right side, a compression-layer front-left side, and a compression-layer zipper, wherein the compression-layer zipper is capable of adaptively connecting the compression-layer front-right side and the compression-layer front-left side to form a closed compression-layer front. The outer layer has an outer-layer back, an outer-layer front-right side, an outer-layer front-left side, and an outer-layer zipper, wherein the outer-layer zipper is capable of adaptively connecting the outer-layer front-right side and the outer-layer front-left side to form a closed outer-layer front. The compression layer is capable of applying uniform pressure to an area of a lower torso covered by the compression layer when the jacket is configured with the closed compression-layer front. The outer layer is capable of covering the compression layer when the jacket is configured with the closed compression-layer front and the closed outer-layer front. The compression layer comprises 3 weight percent to 15 weight percent spandex based upon the total weight of the compression layer and further comprises nylon, polyester, and/or cotton. The compression layer is stretchable in a direction parallel to a bottom edge of the compression-layer back. The jacket, when configured with the closed compression-layer front, can be comfortably worn by a person for a time period from 1 to 14 hours.

### DESCRIPTION OF THE FIGURES

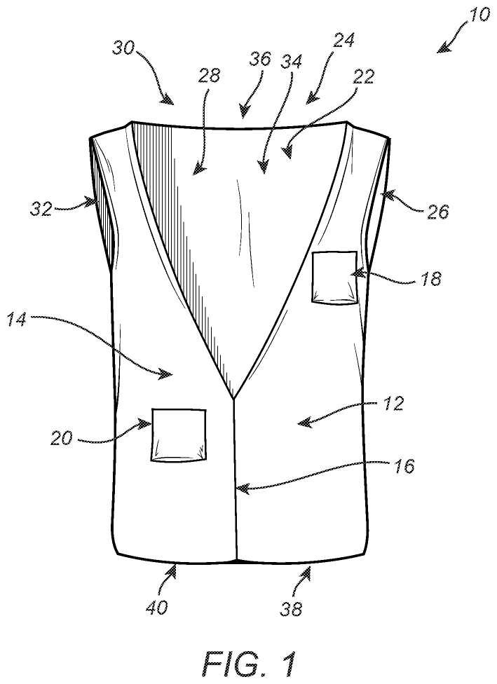

FIG. 1 is a schematic of the front of a non-limiting embodiment of a compression layer 10. Throughout the description, the left and right side of the compression layer 10 are based on the garment when worn by a person. The area capable of covering part of the front-left torso 12 and the area capable of covering part of the front-right torso 14 are connected by closed zipper 16. As front-left section 12 and front-right section 14 have approximately the same width, closed zipper 16 is located in near the center front of the compression layer 10. As many people who would benefit from the invention have multiple medical needs, the compression layer 10 is shown with a port access point 18 which can give access to vagus nerve stimulator (no shown), on the upper part of front left section 12, and a port access point 20 which can give access to gastric tube (not shown) on the lower part of front right section 14. The compression layer 10 is designed to minimize compression forces on the lungs. The front left top edge 22 slopes down from near the inner left shoulder 24, which is above armhole 26, to the top of zipper 16. The front right top edge 28 slopes down from near the inner right shoulder 30, which is above armhole 32, to the top of zipper 16. The inside (torso facing) of the back 34 of the compression layer 10 is shown above the left top edge 22 and the right top edge 28. The back top edge 36, bottom left edge 38, and bottom right edge 40 are also shown.

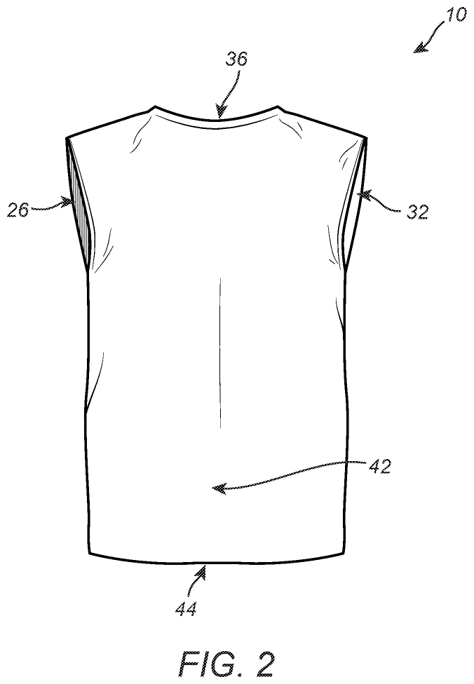

FIG. 2 is a schematic of the back of the same non-limiting embodiment of the compression layer 10 shown in FIG. 1. The left armhole 26, right armhole 32, and the back top edge 36 are shown. The outside of the back 42 (opposite of torso facing) and the back bottom edge 44 are also shown.

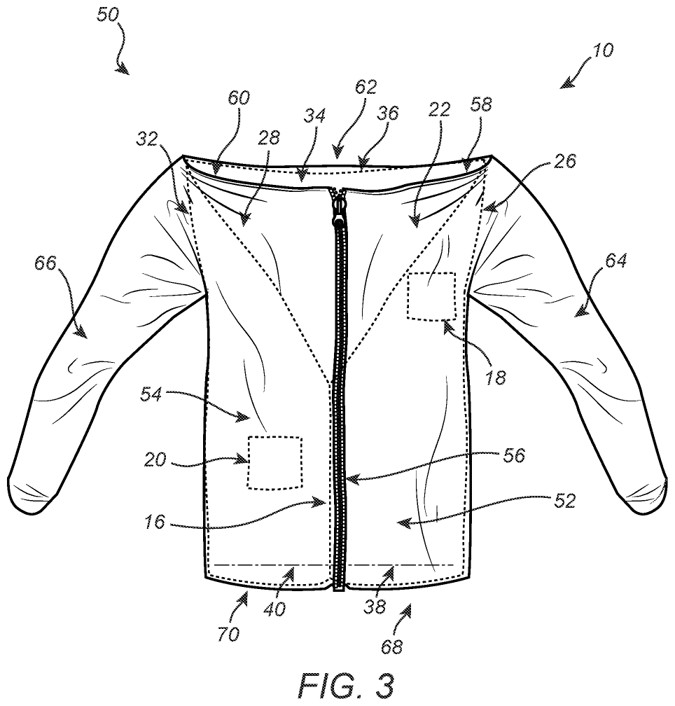

FIG. 3 is a schematic of a front view of a non-limiting embodiment of a jacket 50 with the same non-limiting embodiment of the compression layer 10, shown in FIGS. 1 and 2. The jacket area capable of covering the front-left torso 52 and the area capable of covering part of the front-right torso 54 are connected by closed zipper 56. As front-left section 52 and front-right section 54 have approximately the same width, closed zipper 56 is located in near the center front of jacket 50. The left-front upper edge 58, right-front upper edge 60, and back top edge 62 can be connected to a collar, not shown. Jacket 50 is shown with a left arm 64 extending from armhole 26 and a right arm 66 extending from armhole 32. As shown, jacket front-left bottom edge 68 is lower than the left-front bottom edge 38 of the compression layer 10. Also, jacket right-front bottom edge, 70 is lower than the right-front bottom edge 40 of the compression layer 10. The features of the front of the compression layer 10 are shown with dashed lines to indicate that they are behind the front-left section 52 and front-right section 54 of jacket 50. As can be seen from FIG. 3, when zipper 56 of jacket 50 is closed jacket 50 covers the compression layer 10 so that it is not seen by the public.

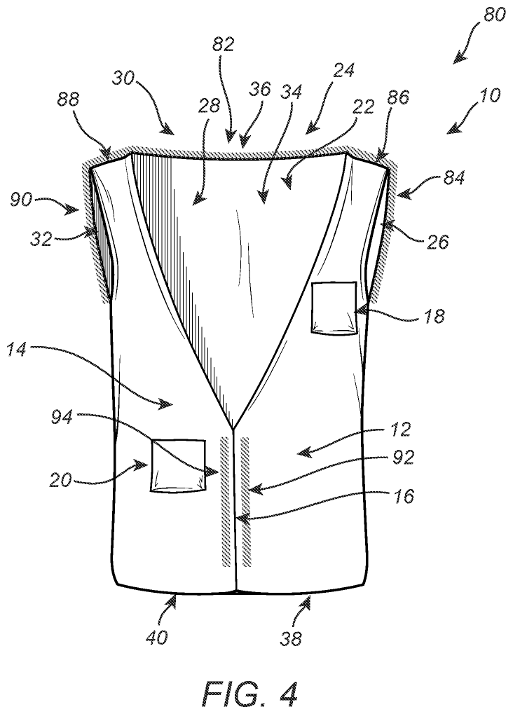

FIG. 4 is a schematic of the front of the non-limiting embodiment of the compression layer 10 with the attachment areas for attaching the compression layer to the analogous areas of the outer layer shown 80. Compression layer 10 is attached to the outer layer, not shown, along shaded line 82 which extends from the bottom of left armhole 26 along the armhole-back edge 82 up to and then across the left shoulder seam 84 to left-front shoulder 24, across back top edge 36, to the right-front inner shoulder 30, across right shoulder seam 88 and down the right armhole 32 along right-back edge 90. As such, part of the left armhole 26 and right armhole 32 of compression layer 10 can be attached to the left armhole and right armhole of an outer layer, not shown. Also, the left shoulder seam 86 and right shoulder seam 88 can be attached to the left shoulder seam and right shoulder seam of a jacket, not shown. The front-left side 12 can be attached to the front-left side of an outer layer, not shown, close to zipper 16 along line 92 on the compression layer. The front-right side can be attached to the front-right side of an outer layer, close to zipper 16 along line 94 on the compression layer.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A therapeutic torso garment comprising: a compression layer and an outer layer,
wherein the compression layer has a compression-layer back, a compression-layer front-right side, and a compression-layer front-left side, wherein the compression-layer front-right side and the compression-layer front-left side are adaptively connectable to form a closed compression-layer front,
wherein the outer layer has an outer-layer back, an outer-layer front-right side, and an outer-layer front-left side, wherein the outer-layer front-right side and the outer-layer front-left side are adaptively connectable to form a closed outer-layer front,
wherein the compression layer is capable of applying uniform pressure to an area of a lower torso covered by the compression layer when the garment is configured with the closed compression-layer front, and
wherein the outer layer is capable of covering the compression layer when the garment is configured with the closed compression-layer front and the closed outer-layer front.

2. The therapeutic torso garment of claim 1, wherein, when a person wears the garment configured with the closed compression-layer front, the compression layer provides deep pressure therapy to the person, whereby the person experiences a reduction in anxiety.

3. The therapeutic torso garment of claim 1,
wherein the compression layer comprises spandex,
wherein the compression layer further comprises nylon, polyester, cotton, and/or wool, and
wherein the compression layer is stretchable in a direction parallel to a back-bottom edge of the compression-layer.

4. The therapeutic torso garment of claim 3, wherein the compression layer comprises 3 weight percent to 15 weight percent spandex based upon the total weight of the compression layer.

5. The therapeutic torso garment of claim 1, wherein the garment, when configured with the closed compression-layer front is capable of being comfortably worn by a person for a period of time from 1 hour to 14 hours.

6. The therapeutic torso garment of claim 1,
wherein at least some parts of the outside of the compression layer contact corresponding parts of the inside of the outer layer,
wherein the top-back edge of the compression layer is attached to the top-back edge of the outer layer,
wherein the back-left armhole of the compression layer is attached to the back-left armhole of the outer layer, and the back-right armhole of the compression layer is attached to the back-right armhole of the outer layer,
wherein the left front of the compression layer is attached to the left front of the outer layer along a line parallel to a left-front edge of the compression layer and a left-front edge of the outer layer, and
wherein the right front of the compression layer is attached to the right front of the outer layer along a line parallel to a right-front edge of the compression layer and a right-front edge of the outer layer.

7. The therapeutic torso garment of claim 1,
wherein the compression layer comprises a zipper, hook and loop fasteners, snaps, and/or buttons to adaptively connect the compression-layer front-right side and the compression-layer front-left side, and
wherein the outer layer comprises a zipper, hook and loop fasteners, snaps, and/or buttons to adaptively connect the outer-layer front-right side and the outer-layer front-left side.

8. The therapeutic torso garment of claim 1,
wherein the compression layer further comprising at least one port access point,
wherein the at least one port access point is capable of providing access to a vagus nerve stimulator and/or gastric tube.

9. The therapeutic torso garment of claim 1, wherein the garment is selected from the group consisting of a jacket, a vest, a sweater, and a shirt.

10. The therapeutic torso garment of claim 1, wherein the garment is machine washable.

11. The therapeutic torso garment of claim 1, wherein the uniform pressure applied by the compression layer is equivalent to a hug being given to a person.

12. A therapeutic jacket comprising: a compression layer and an outer layer,
wherein the compression layer has a compression-layer back, a compression-layer front-right side, and a compression-layer front-left side, wherein the compression-layer front-right side and the compression-layer front-left side are adaptively connectable to form a closed compression-layer front,
wherein the outer layer has an outer-layer back, an outer-layer front-right side, and an outer-layer front-left side, wherein the outer-layer front-right side and the outer-layer front-left side are adaptively connectable to form a closed outer-layer front,
wherein the compression layer is capable of applying uniform pressure to an area of a lower torso covered by the compression layer when the jacket is configured with the closed compression-layer front, and
wherein the outer layer is capable of covering the compression layer when the jacket is configured with the closed compression-layer front and the closed outer-layer front.

13. The therapeutic jacket of claim 12, wherein, when a person wears the jacket configured with the closed compression-layer front, the compression layer provides deep pressure therapy to the person, whereby the person experiences a reduction in anxiety.

14. The therapeutic jacket of claim 12,
wherein the compression layer comprises 3 weight percent to 15 weight percent spandex based upon the total weight of the compression layer,
wherein the compression layer further comprises nylon, polyester, and/or cotton, and
wherein the compression layer is stretchable in a direction parallel to a back-bottom edge of the compression-layer.

15. The therapeutic jacket of claim 12, wherein the jacket, when configured with the closed compression-layer front, is capable of being comfortably worn by a person for a time period from 1 hour to 14 hours.

16. The therapeutic jacket of claim 12,
wherein at least some parts of the outside of the compression layer contact corresponding parts of the inside of the outer layer,
wherein the top-back edge of the compression layer is attached to the top-back edge of the outer layer,
wherein the back-left armhole of the compression layer is attached to the back-left armhole of the outer layer, and the back-right armhole of the compression layer is attached to the back-right armhole of the outer layer,
wherein the left front of the compression layer is attached to the left front of the outer layer along a line parallel to a left-front edge of the compression layer and a left-front edge of the outer layer, and
wherein the right front of the compression layer is attached to the right front of the outer layer along a line parallel to a right-front edge of the compression layer and a right-front edge of the outer layer.

17. The therapeutic jacket of claim 12,
wherein the compression layer comprises a zipper to adaptively connect the compression-layer front-right side and the compression-layer front-left side, and
wherein the outer layer comprises a zipper to adaptively connect the outer-layer front-right side and the outer-layer front-left side.

18. The therapeutic jacket of claim 12,
wherein the compression layer further comprises at least one port access point,
wherein the at least one port access point is capable of providing access to a vagus nerve stimulator and/or gastric tube.

19. The therapeutic jacket of claim 13, wherein the jacket is machine washable.

20. A therapeutic jacket comprising: a compression layer and an outer layer,
wherein the compression layer has a compression-layer back, a compression-layer front-right side, a compression-layer front-left side, and a compression-layer zipper, wherein the compression-layer zipper is capable of adaptively connecting the compression-layer front-right side and the compression-layer front-left side to form a closed compression-layer front,
wherein the outer layer has an outer-layer back, an outer-layer front-right side, an outer-layer front-left side, and an outer-layer zipper, wherein the outer-layer zipper is capable of adaptively connecting the outer-layer front-right side and the outer-layer front-left side to form a closed outer-layer front,
wherein the compression layer is capable of applying uniform pressure to an area of a lower torso covered by the compression layer when the jacket is configured with the closed compression-layer front,
wherein the outer layer is capable of covering the compression layer when the jacket is configured with the closed compression-layer front and the closed outer-layer front,
wherein the compression layer comprises 3 weight percent to 15 weight percent spandex based upon the total weight of the compression layer,
wherein the compression layer further comprises nylon, polyester, and/or cotton,
wherein the compression layer is stretchable in a direction parallel to a bottom edge of the compression-layer back, and
wherein the jacket, when configured with the closed compression-layer front, can be comfortably worn by a person for a period of time from 1 to 14 hours.
